(19) United States
(12) Patent Application Publication
(10) Pub. No.: US 2026/0324687 A1
(43) Pub. Date: Oct. 22, 2026

(54) Maple Sap Drink By Reverse Osmosis

(71) Applicants: Reginal Osagie Akpata, Pleasant Valley, NY (US); Henrietta Akpata, Pleasant Valley, NY (US)

(72) Inventors: Reginal Osagie Akpata, Pleasant Valley, NY (US); Henrietta Akpata, Pleasant Valley, NY (US)

(21) Appl. No.: 19/184,471

(22) Filed: Apr. 21, 2025

(51) Int. Cl. A23L 2/38; A23L 2/385; A23L 2/74; A23L 29/30

(52) U.S. Cl. CPC A23L 2/38; A23L 2/385; A23L 2/74; A23L 29/30

(57) ABSTRACT

A method for producing natural Maple Sap drinks with varying sugar content using a multi-stage process. The invention incorporates double filtration with progressively finer meshes, followed by controlled reverse osmosis and followed by double filtration. Instead of discarding the permeate, it and the concentrate are utilized to create beverages of differing sugar content. This process is a prelude to introducing the Maple Sap to cold chain storage as natural finished products.

### 1. BACKGROUND OF THE INVENTION

1.1. For thousands of years indigenous peoples of the Mohican-Algonquin-Mohawk peoples of the North East American continent have used sap from an indigenous tree Acer Saccharum (The Maple Tree) for many remedies and foods, beginning with drinking pure Maple Sap.

1.2. Currently Maple Sap is processed via reverse osmosis to reduce boiling time in the process of creating maple syrup and sugars. The extracted water from the reverse osmosis process is discarded.

1.3. This invention seeks to introduce a process of obtaining a variety of different sugar levels of Maple Sap drink through the use of reverse osmosis.

### 2. DETAILED DESCRIPTION OF THE INVENTION

2.1. The invention known as the Maple Sap Drink By Reverse Osmosis is an invention in the USPTO categories:
2.1.1. Classification 47, Plant Husbandry
2.1.2. Classification A23L2/38—Other non-alcoholic beverages
2.1.3. Classification A23L 2/085—By reverse osmosis

2.2. Currently Maple Sap is processed via reverse osmosis to reduce boiling time in the process of creating maple syrup and sugars. The excess water from the reverse osmosis process is discarded.

2.3. This invention seeks to introduce a process of obtaining a variety of different sugar levels and purity of Maple Sap drink through the use of reverse osmosis.

2.4. Prior to and after the reverse osmosis, our specific approach utilizes double filtration with progressively finer meshes to derive products both the permeate and concentrate.

2.5. This process is a prelude to introducing the Maple Sap to cold chain storage as natural finished products.

### 3. BRIEF DESCRIPTION OF THE DRAWINGS OF THE INVENTION

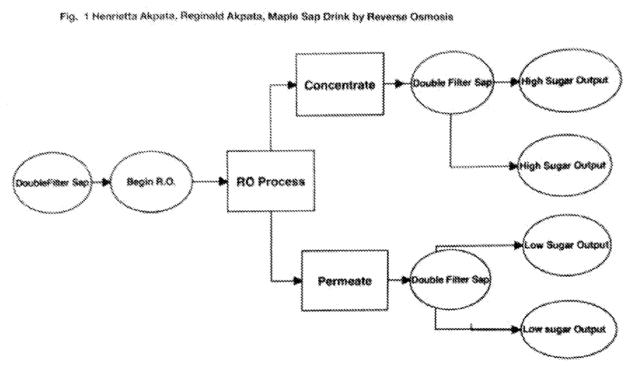

3.1. FIG. 1 depicts the process flow for producing Maple Sap drinks with varying Brix levels, representing natural sugar content. The diagram outlines the sequential steps, including double filtration with progressively finer meshes, reverse osmosis separation.

### 4. CITATIONS

| Publication | Priority | Publication | | |
|---|---|---|---|---|
| Number | Date | Date | Assignee | Title |
| US3397062A | 1964 Oct. 13 | 1968 Aug. 13 | Raymond S. | Maple product for beverage, flavoring |
| | | | Nessly | and the like |
| US3573927A | 1969 Jun. 4 | 1971 Apr. 6 | Raymond S. | Method and products of processing |
| | | | Nessly | raw maple sap |
| US3934042A | 1973 Jul. 13 | 1976 Jan. 20 | William Patrick De | Method and apparatus for the |
| | | | Stoutz | irradiative treatment of beverages |
| KR100497048B1 | 2002 Nov. 29 | 2005 Jun. 28 | [symbol] (Jeong | Sterilization methods for sap and sap |
| | | | Man-woon) | beverage thereof |
| US7420183B2 | 2003 Mar. 21 | 2008 Sep. 2 | Bayer Technology | Apparatus and process for |
| | | | Services GmbH | sterilization of liquid media by means |
| | | | | of UV irradiation and short-time heat |
| | | | | treatment |
| CN101496625A | 2009 Mar. 9 | 2009 Aug. 5 | [symbol] (Ma Defu) | Method for preparing Schisandra |
| | | | | chinensis drink |
| KR20100091076A | 2009 Feb. 9 | 2010 Aug. 18 | [symbol] (Kwon | Gorro sap mixed beverage |
| | | | Oh-seok) | preparation method |
| US20110052759A1 | 2009 Sep. 1 | 2011 Mar. 3 | Eau Matelo Inc. | Process to extract drinking water from |
| | | | | plant, plant drinking water and |
| | | | | beverages thereof |
| US20130052298A1 | 2010 May 11 | 2013 Feb. 28 | Bandupala | Plant-based electrolyte compositions |
| | | | Wijesinghe | |
| US20140010930A1 | 2011 Mar. 16 | 2014 Jan. 9 | Federation Des | Apparatus and process for |
| | | | Producteurs | pasteurization of sap and product |
| | | | Acericoles Du | thereof |
| | | | Quebec | |

1. The process of separating permeate from concentrate will lead to the delivery of drinking Maple Sap in a variety of natural sugar levels. The separation of Maple Sap by sugar levels will enable the production of specific Maple Sap drinks based on the resulting natural sugar content.
